(19) United States
(12) Patent Application Publication
(10) Pub. No.: US 2026/0229589 A1
(43) Pub. Date: Aug. 6, 2026

(54) POLYMER ELECTROLYTE COMPOSITION

(71) Applicant: BASQUEVOLT S.A., Vitoria-Gasteiz, Álava (ES)

(72) Inventors: María MARTÍNEZ-IBÁÑEZ, Vitoria-Gasteiz, Álava (ES); Michel ARMAND, Vitoria-Gasteiz, Álava (ES); Mikel ARRESE-IGOR, Vitoria-Gasteiz, Álava (ES); Leire MEABE, Vitoria-Gasteiz, Álava (ES); Lorena GARCÍA, Vitoria-Gasteiz, Álava (ES); Iñigo RAPOSO, Vitoria-Gasteiz, Álava (ES); Nicola BOARETTO, Vitoria-Gasteiz, Álava (ES); Aitor VILLAVERDE OREJÓN, Vitoria-Gasteiz, Álava (ES); Maria Carmen MORANT MIÑANA, Victoria-Gasteiz, Álava (ES); Vincent GIORDANI, Victoria-Gasteiz, Alava (ES)

(21) Appl. No.: 19/149,411

(22) PCT Filed: Sep. 28, 2023
(86) PCT No.: PCT/EP2023/076855

§ 371 Date: Jul. 18, 2025

(30) Foreign Application Priority Data
Jan. 25, 2023 (EP) 23382059.6

(51) Int. Cl. H01M 10/056; C08J 3/205; C08J 3/21; C08J 3/24; C08K 5/43; H01M 10/0525

(52) U.S. Cl. CPC H01M 10/056; C08J 3/2053; C08J 3/212; C08J 3/24; C08K 5/43; H01M 10/0525; C08J 2333/08; C08J 2333/14; H01M 2300/0065; H01M 2300/0091

(57) ABSTRACT

The present invention relates to a polymer electrolyte composition comprising a lithium salt of (difluoromethanesulfonyl)(trifluoromethanesulfonyl)imide and a second lithium salt. The invention also relates to an electrochemical cell or battery comprising said polymer electrolyte composition and to a method for the preparation of said polymer electrolyte composition.

### FIELD OF THE INVENTION

The present invention relates to a polymer electrolyte composition comprising a lithium salt of (difluoromethanesulfonyl)(trifluoromethanesulfonyl)imide and a second lithium salt. The invention also relates to an electrochemical cell or battery comprising said polymer electrolyte composition and to a method for the preparation of said polymer electrolyte composition.

### BACKGROUND

Portable electronic devices are currently being used on a daily basis and are gaining popularity. In this regard, numerous efforts are being made in developing new technologies aiming at improving the energy efficiency of said devices. Certain aspects are the object of intensive research and relate to the capacity of the battery of said devices to store large amounts of energy over the whole useful lifetime of the device. In particular, it is not only necessary that the battery is suitable for storing a large amount of energy but it is also necessary that this capacity is preserved when the battery is submitted to frequent charge and discharge cycles. The charge capacity and capacity retention of a battery depends on a large range of parameters, each of which may be independently optimized, including the cathode material and structure, the nature of the electrolyte (or diaphragm) and the anode material. In this regard, the use of anodes comprising lithium metal holds great promise as these exhibit improved energy density if compared with conventional lithium-ion batteries. Polymer electrolytes are believed to be particularly useful in the implementation of Li-metal batteries, for they contribute in preventing the formation of lithium dendrites on the electrode surface while favouring the deposition of lithium in a uniform manner on the anode.

Polymer electrolytes are compositions comprising a polymer and capable of conducting ions, such as a lithium cation. When used in lithium-metal batteries, they are responsible for transferring lithium cations from the anode to the cathode. Lithium cations are transported through the polymer electrolyte via non-covalent interactions between the lithium cation and heteroatoms, such as halogen, O, N and S, present on the side chain or the repeating unit(s) of the polymers comprised in the electrolyte. Polymer electrolytes typically also comprise a lithium salt soluble in the medium forming the electrolyte and responsible for pre-organizing the system and conferring conductivity to the electrolyte while limiting the formation of ohmic drops during the operation of the battery. Several types of polymer electrolytes are known in the art, depending on the polymer forming the electrolyte: solid-state polymer electrolytes, gel polymer electrolytes, plasticized polymer electrolytes and composite polymer electrolytes. The components making a polymer electrolyte (e.g. polymer, lithium salt, plasticizer or solvent, etc) have been the object of independent studies aiming at optimizing the properties of polymer electrolytes in terms of conductivity, electrochemical stability and capacity to preserve the capacity of the battery upon charging.

An example of such polymer electrolytes has been reported by Yuki Kato and co-workers in “Polymer electrolyte plasticized with PEG-borate ester having high ionic conductivity and thermal stability” Solid State Ionics, Volume 150, Issues 3-4, 2002, 355-361. The disclosed polymer electrolyte is prepared by co-polymerization of poly(ethyleneglycol)methacrylate and poly(ethyleneglycol)dimethacrylate induced by light irradiation and employs bis(trifluoromethane)sulfonimide lithium salt (LiTFSl) as lithium salt. Varying amounts of borate esters of polyethylene glycol are further employed as plasticizers. According to the authors, the conductivity of the electrolyte increases with an increasing proportion of plasticizer in the electrolyte formulation. The authors conclude that the reported electrolyte based on poly(ethylene glycol)acrylate is sufficiently stable electrochemically for being applied in lithium ion batteries.

Different lithium salts have been reported in the art as being useful for the formulation of polymer electrolytes. Such salts are typically those that are soluble in the polymer electrolyte and can interact via non-covalent interactions (e.g. Van der Waals and/or hydrophobic interactions) with the polymer of the electrolyte. The strength of these interactions impacts directly on the capacity of the electrolyte to transport lithium cations. Bis(trifluoromethane)sulfonimide lithium salt (LiTFSl) is broadly used in the art as component for polymer electrolyte compositions. Zhang and co-workers report in “Enhanced Li-ion conductivity of polymer electrolytes with selective introduction of hydrogen in the anion” Angewandte Chemie Int. Ed. 2019, Vol. 58. Issue 23, 7829-7834, an alternative salt, analogous salts to LiTFSl whereby one or more of the F atoms are replaced with H atoms, in particular a compound of formula (I)

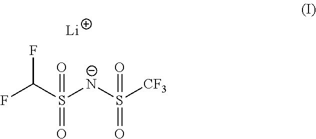 [SMILES: [Li+] ; O=S(=O)([N-]S(=O)(=O)C(F)(F)F)C(F)F]

The compound of formula (I) was in particular shown to effectively enhance the Li-ion conductivity of electrolytes based on polyethylene oxide if compared with LiTFSl, while not affecting significantly the overall conductivity of the electrolyte, thus teaching that this compound is useful as component of a polymer electrolyte.

In addition, Qiao L. and co-workers disclose in “Stable non-corrosive sulfonimide salt for 4-V-class lithium metal batteries” Nature Materials 2022, vol. 21, 455-462 an electrolyte composition comprising a mixture of organic carbonates and lithium (difluoromethyl(trifluoromethyl)sulfonamide (LiDFTSl) as lithium salt.

Zhang, H and co-workers disclose in “Designer Anion Enabling Solid-State Lithium-Sulfur Batteries”, Joule, Volume 3, Issue 7, 2019, Pages 1689-1702 polymer electrolyte compositions comprising polyethylene oxide and lithium (difluoromethanesulfonyl)(trifluoromethanesulfonyl)imide (LiDFTFSl) as lithium salt. This document further teaches that this salt forms a passivation layer comprising lithium fluoride and lithium hydride on the Li(O) anode which contributes in improving long-term cyclability of the battery by preventing the formation of lithium dendrites on the anode observed with other lithium salts such as lithium bis(trifluoromethylsulfonyl)imide LiTFSl.

From what is disclosed in the art, it derives that there is still a need for providing improved polymer electrolyte compositions for alkaline batteries, in particular electrolytes for lithium batteries having a high degree of retention of charge capacity upon cycling, for lithium batteries operating at high voltages and/or low temperatures, and/or electrolytes inducing less corrosion when used in lithium batteries.

### SUMMARY OF THE INVENTION

After exhaustive research, the inventors have developed a polymer electrolyte composition comprising a compound of formula (I) as defined above combined with a further lithium salt. The inventors have found in particular that the charge retention capacity of a lithium metal battery comprising a polymer electrolyte comprising the combination of said lithium salts is increased if compared with the charge retention capacity of the comparative lithium metal battery comprising a polymer electrolyte comprising each of the aforementioned lithium salts as sole lithium salts. This synergistic effect of both lithium salts is unexpected in view of the prior art. In addition, the electrolyte of the invention advantageously allows operating the battery at potentials as high as 4.25 V vs Li/Li⁺ at room temperature while maintaining the charge retention capacity. The batteries comprising the electrolyte of the invention are also surprisingly less prompt to be subject to corrosion.

Thus, in a first aspect, the invention relates to a polymer electrolyte composition comprising:
a) a polymer for electrolyte;
b) a first lithium salt of formula (I)

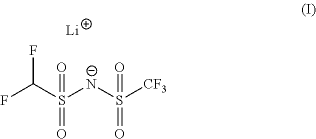 [SMILES: [Li+] ; O=S(=O)([N-]S(=O)(=O)C(F)(F)F)C(F)F]

and c) a second lithium salt suitable for lithium metal batteries electrolytes.

A second aspect of the invention relates to an electrochemical cell or a battery comprising a polymer electrolyte according to the first aspect of the invention.

A third aspect of the invention relates to a method for the preparation of a polymer electrolyte according to the first aspect of the invention comprising the steps of:
(i) providing a lithium salt of formula (I) as defined in the first aspect of the invention;
(ii) providing a second lithium salt as defined in the first aspect of the invention; and in a first alternative,
(iii) dissolving the lithium salts provided in steps (i) and (ii) in a polymer for electrolyte;
or,
in a second alternative,
(iv) dissolving the lithium salts provided in steps (i) and (ii) in a solvent, and
(v) dissolving a polymer for electrolyte in the mixture obtained in step (iv);
and
(vi) optionally, cross-linking the polymer for electrolyte comprised in the mixture resulting from step (iii) or (v).

### BRIEF DESCRIPTION OF THE DRAWINGS

FIG. 1 shows the specific discharge capacity (expressed in mAh·g⁻¹) as a function of the number of charging/discharging cycles carried out as disclosed in Example 2 of a Li battery and comprising lithium bis(oxalate)borate as sole lithium salt ((▪) Charge capacity (□) Discharge capacity).

FIG. 2 shows the specific discharge capacity (expressed in mAh·g⁻¹) as a function of the number of charging/discharging cycles carried out as disclosed in Example 2 of a Li battery and comprising a compound of formula (I) as sole lithium salt((▪) Charge capacity (□) Discharge capacity).

FIG. 3 shows the specific discharge capacity (expressed in mAh·g⁻¹) as a function of the number of charging/discharging cycles carried out as disclosed in Example 2 of a Li battery and comprising a combination of lithium bis(oxalate)borate and a compound of formula (I) as lithium salts((▪) Charge capacity (□) Discharge capacity).

FIG. 4 shows the specific discharge capacity (expressed in mAh·g⁻¹) as a function of the number of charging/discharging cycles carried out as disclosed in Example 2 of the batteries 4 (filled square symbols) and 5 (empty square symbols) of Example 2.

### DETAILED DESCRIPTION

All terms as used herein in this application, unless otherwise stated, shall be understood in their ordinary meaning as known in the art. Other more specific definitions for certain terms as used in the present application are as set forth below and are intended to apply uniformly throughout the specification and claims unless an otherwise expressly set out definition provides a broader definition.

For the purposes of the invention, any ranges given include both the lower and the upper end-points of the range. Ranges or values given, such as temperatures, times, molar ratio, volume ratio and the like, should be considered approximate when they are defined by the term “about” (i.e. with a 5% margin of variation around indicated point).

In the context of the invention, the term “plasticizer” refers to a substance suitable for softening a polymer. Examples of plasticizers are known in the art and include, among others, organic solvents and compounds such as dimethoxy ethane (DME), 1,2-Diethoxyethane (DEE), 1,3-Dioxolane (DOL), Diethyleneglycol dimethyl ether (DEGDME), Triethylene glycol dimethyl ether (G3), tetraethylene glycol dimethyl ether (TEGDME), Poly(ethylene glycol) dimethyl ether (PEGDME), tetrahydropyran (THP), γ-butyrolactone, tetrahydrofuran (THF), 2-methyltetrahydrofuran, diethylether, methyl-tert-butylether, succinonitrile (SN), glutaronitrile (GN), adiponitrile (AN), N,N-dimethylsulfamoyl fluoride (FSA), N,N-dimethyltrifluoromethane-sulfonamide (TFSA), ethyl methyl carbonate (EMC), dimethyl carbonate (DMC), propylene carbonate (PC), ethylene carbonate (EC), fluoroethylene carbonate (FEC), difluoroethylene carbonate (DFEC), and any mixtures thereof.

In the context of the invention, the term “polymer electrolyte” refers to a material comprising a polymer material suitable for conducting ions, in particular lithium cations, via non-covalent interactions between the polymer chain and the ion. Suitable polymers for polymer electrolytes are known in the art and typically comprise a heteroatom such as O, N, S or P in the repeating unit of the polymer chain that is suitable for interacting with a lithium cation through a lone pair of the heteroatom. A non-exhaustive list of polymers for forming a polymer electrolyte includes polyalkylene oxides, polyalkylenimines, polyalkylene sulphides, polyalkylene carbonates, polyacrylates, polyurethanes, polyethyleneglycol optionally comprising one or more cross-linkable groups, polyphosphazenes, polysiloxanes, polyvinyl alcohol (PVA), polyvinyl amine (PVAm), polyvinyl acetate (PVAc), polyvinyl halides, polyacrylonitrile (PAN), poly(vinylpyrrolidone) (PVP), poly(2-vinylpyridine) (P2VP), poly(ε-caprolactone) (PCL), poly(maleimide), polyaniline (PANI), chitosan (CS), and any blend or any copolymer or any cross-linked polymer thereof. In addition, a polymer for electrolyte according to the present invention may comprise in its molecular formula at least one cross-linkable functional group, such as (meth)acrylate, epoxy, alkene, thiol, amino, hydroxy and other cross-linkable functional groups known in the art. Alternatively, a polymer for electrolyte according to the present invention may be a cross-linked product.

In the context of the invention, the term “acrylate” refers to a compound comprising a moiety of formula:

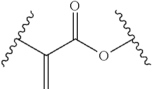 [SMILES: *OC(=O)C(*)=C]

This term thus encompasses acrylate compounds, alkylacrylate compounds, such as methacrylate compounds, and cyanoacrylate compounds, among others.

In the context of the invention, the term “(meth)acrylate” refers either to an acrylate compound or to a methacrylate compound.

In the context of the invention, the term “alkyl” refers to a saturated aliphatic hydrocarbon chain having the number of atoms disclosed in the description and in the claims. Thus, “alkyl” may refer to methyl, ethyl, propyl, i-propyl, butyl, t-butyl, pentyl and hexyl, among others.

As mentioned above, a first aspect of the invention relates to a polymer electrolyte composition comprising:
a) a polymer for electrolyte;
b) a first lithium salt of formula (I)

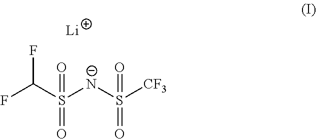 [SMILES: [Li+] ; O=S(=O)([N-]S(=O)(=O)C(F)(F)F)C(F)F]

and c) a second lithium salt suitable for lithium metal batteries electrolytes.

Said second lithium salt may be inorganic or organic. Preferably, the second lithium salt is selected from the group consisting of lithium perchlorate, lithium nitrate, lithium tetrafluoroborate, lithium hexafluoroarsenate, lithium hexafluorophosphate, lithium chlorotrifluoroborate, lithium fluoride, lithium oxide, lithium peroxide, a salt of formula LiN(SO₂CF₃)₂, a salt of formula LiN(SO₂F)₂, a salt of formula LiN(SO₂CF₃)(SO₂F), a salt of formula LiN(SO₂C₂F₅)(SO₂F), a salt of formula LiB(C₂O₄)₂, a salt of formula LiBF₂(C₂O₄), a salt of formula LiC(SO₂CF₃)₃, a salt of formula LiPF₃(C₂F₅)₃, a salt of formula LiCF₃SO₃ and mixtures thereof.

In further embodiments, the electrolyte composition of the first aspect is one wherein the second lithium salt is not lithium fluoride. The skilled person will appreciate that this embodiment does not exclude the formation of lithium fluoride as component of a Solid Electrolyte Interface (SEI), e.g. by decomposition of LiDFTSl, between the electrolyte and the anode of the battery, when said electrolyte is for use in a lithium metal battery. Thus, in a more preferred embodiment, the second lithium salt is selected from the group consisting of lithium perchlorate, lithium nitrate, lithium tetrafluoroborate, lithium hexafluoroarsenate, lithium hexafluorophosphate, lithium chlorotrifluoroborate, lithium oxide, lithium peroxide, a salt of formula LiN(SO₂CF₃)₂, a salt of formula LiN(SO₂F)₂, a salt of formula LiN(SO₂CF₃)(SO₂F), a salt of formula LiN(SO₂C₂F₅)(SO₂F), a salt of formula LiB(C₂O₄)₂, a salt of formula LiBF₂(C₂O₄), a salt of formula LiC(SO₂CF₃)₃, a salt of formula LiPF₃(C₂F₅)₃, a salt of formula LiCF₃SO₃ and mixtures thereof.

In a more preferred embodiment of the first aspect of the invention, the second lithium salt is selected from the group consisting of lithium tetrafluoroborate, lithium hexafluoroarsenate, lithium hexafluorophosphate, lithium chlorotrifluoroborate, a salt of formula LiB(C₂O₄)₂, a salt of formula LiBF₂(C₂O₄), a salt of formula LiPF₃(C₂F₅)₃, a salt of formula LiCF₃SO₃ and mixtures thereof.

In another preferred embodiment of the first aspect of the invention, the second lithium salt is an organic lithium salt, that is preferably selected from the group consisting of a salt of formula LiN(SO₂CF₃)₂, a salt of formula LiN(SO₂F)₂, a salt of formula LiN(SO₂CF₃)(SO₂F), a salt of formula LiN(SO₂C₂F₅)(SO₂F), a salt of formula LiB(C₂O₄)₂, a salt of formula LiBF₂(C₂O₄), a salt of formula LiC(SO₂CF₃)₃, a salt of formula LiPF₃(C₂F₅)₃, a salt of formula LiCF₃SO₃ and mixtures thereof.

In another preferred embodiment of the first aspect of the invention, the second lithium salt is a salt of formula LiB(C₂O₄)₂ that is lithium bis(oxalate)borate. In another preferred embodiment of the first aspect of the invention, the second lithium salt is a salt of formula LiBF₂(C₂O₄) that is lithium difluoro(oxalate)borate (LiDFOB).

In another preferred embodiment of the first aspect of the invention, the weight ratio of the first lithium salt to the second lithium salt is comprised from 1:1 to 4:1; preferably it is comprised from 1:1 to 3:1 and more preferably it is comprised from 1:1 to 2:1. In an even more preferred embodiment of the first aspect of the invention, the weight ratio of the first lithium salt to the second lithium salt is of about 112:81. In an even more preferred embodiment of the first aspect of the invention, the weight ratio of the first lithium salt to the second lithium salt is of about 114:82. In an even more preferred embodiment of the first aspect of the invention, the weight ratio of the first lithium salt to the second lithium salt is of about 95:51.

In a further preferred embodiment of the first aspect of the invention, the lithium salts comprised in the polymer electrolyte composition represent from 5% to 60% in weight of the composition.

In a further more preferred embodiment of the first aspect of the invention, the 10 lithium salts comprised in the polymer electrolyte composition represent from 10% to 50% in weight of the composition.

In a further more preferred embodiment of the first aspect of the invention, the lithium salts comprised in the polymer electrolyte composition represent from 10% to 30% in weight of the composition. In a further more preferred embodiment of the first aspect of the invention, the lithium salts comprised in the polymer electrolyte composition represent from 15% to 25% in weight of the composition.

In a further more preferred embodiment of the first aspect of the invention, the lithium salts comprised in the polymer electrolyte composition represent about 20% of the weight of the composition.

In another embodiment of the first aspect of the invention, the second lithium salt is lithium bis(oxalate)borate or lithium difluoro(oxalate)borate LiBF₂(C₂O₄) (LiDFOB) and:
the weight ratio of the first lithium salt to the second lithium salt is comprised from 1:1 to 4:1; preferably it is comprised from 1:1 to 3:1 and more preferably it is comprised from 1:1 to 2:1; and/or
the lithium salts comprised in the polymer electrolyte composition represent from 10% to 50% in weight of the composition; preferably, the lithium salts comprised in the polymer electrolyte composition represent from 10% to 30% in weight of the composition; even more preferably, the lithium salts comprised in the polymer electrolyte composition represent from 15% to 25% in weight of the composition.

In a further embodiment of the first aspect of the invention, the first lithium salt of formula (I) is in an amount of between 5% and 40% in weight of the composition; preferably it is in an amount of between 5% and 15% in weight of the composition. More preferably, the first lithium salt of formula (I) is in an amount of about 11.2% in weight of the composition, or of about 11.4% in weight of the composition, or of about 9.5% weight of the composition.

In a further embodiment of the first aspect of the invention, the second lithium salt is in an amount of between 5% and 20% in weight of the composition; preferably, between 5% and 10% in weight of the composition. More preferably, the second lithium salt is in an amount of about 8.1% of the composition. In further preferred embodiments, the second lithium salt is in an amount of about 8.2% of the composition. In further preferred embodiments, the second lithium salt is in an amount of about 5.1% of the composition.

In a further embodiment of the first aspect of the invention, the polymer is in the form of a cross-linked polymer or in the form of a cross-linkable polymer. composition.

In a further embodiment of the first aspect of the invention, the polymer comprises in its molecular formula one or more cross-linkable functional groups such as (meth)acrylate, epoxy, alkene, thiol, amino, hydroxy and other cross-linkable functional groups known in the art.

In a further embodiment of the first aspect of the invention, the polymer optionally comprises in its molecular formula one or more cross-linkable functional groups and is selected from the group consisting of:
a polyalkylene oxide such as polyethylene oxide (PEO) or polypropylene oxide (PPO),
a polyalkylenimine such as polyethyleneimine (PEI),
a polyalkylene sulphide such as polyethylene sulphide (PES),
a polyalkylene carbonate such as polytrimethylenecarbonate (PTMC), polyethylenecarbonate (PEC) or polypropylenecarbonate (PPC),
a polyacrylate, such as polymers of methylmethacrylate (PMMA), (C₁-C₆)alkyl acrylate such as butyl acrylate (PBA) or ethyl acrylate (PEA), cyanoethylacrylate (PCEA), or blends thereof or co-polymers thereof or cross-linked polymers thereof with trimethylolpropane triacrylate (ETPTA) and/or pentaerythritol tetraacrylate (PETA),
a polyethyleneglycol,
a polyphosphazene, such as poly[bis(2-(2-methoxyethoxy) ethoxy) phosphazene (MEEP),
a polysiloxane, such as poly(dimethyl siloxane) (PDMS),
polyvinyl alcohol (PVA),
polyvinyl amine (PVAm),
polyvinyl acetate (PVAc),
polyvinyl halide such as polyvinyl chloride (PVC) or polyvinylidene difluoride (PVdF);
polyvinylidene difluoride-hexafluropropylene (PVdF-HFP),
polyacrylonitrile (PAN),
poly(vinylpyrrolidone) (PVP),
poly(2-vinylpyridine) (P2VP),
poly(ε-caprolactone) (PCL),
poly(maleimide), such as poly(alkylenemaleimide), poly(ethylene-alt-maleimide) (PEaMI),
polyaniline (PANI),
chitosan (CS), and
any blend or any copolymer or any cross-linked polymer thereof.

In a further embodiment of the first aspect of the invention, the polymer is selected from the group consisting of:
a polyalkylene oxide such as polyethylene oxide (PEO) or polypropylene oxide (PPO),
a polyalkylenimine such as polyethyleneimine (PEI),
a polyalkylene sulphide such as polyethylene sulphide (PES),
a polyalkylene carbonate such as polytrimethylenecarbonate (PTMC), polyethylenecarbonate (PEC) or polypropylenecarbonate (PPC),
a polyacrylate, such as polymers of methylmethacrylate (PMMA), (C₁-C₆)alkyl acrylate such as butyl acrylate (PBA) or ethyl acrylate (PEA), cyanoethylacrylate (PCEA), or blends thereof or co-polymers thereof or cross-linked polymers thereof with trimethylolpropane triacrylate (ETPTA) and/or pentaerythritol tetraacrylate (PETA),
a polyethyleneglycol optionally comprising one or more cross-linkable groups, such as poly(ethyleneglycol), poly(ethyleneglycol) methacrylate (PEGMA), poly(ethyleneglycol) methyl ether methacrylate, poly(ethyleneglycol) dimethacrylate (PEGDMA),
a polyphosphazene, such as poly[bis(2-(2-methoxyethoxy) ethoxy) phosphazene (MEEP),
a polysiloxane, such as poly(dimethyl siloxane) (PDMS),
polyvinyl alcohol (PVA),
polyvinyl amine (PVAm),
polyvinyl acetate (PVAc),
polyvinyl halide such as polyvinyl chloride (PVC) or polyvinylidene difluoride (PVdF);
polyvinylidene difluoride-hexafluropropylene (PVdF-HFP),
polyacrylonitrile (PAN),
poly(vinylpyrrolidone) (PVP),
poly(2-vinylpyridine) (P2VP),
poly(ε-caprolactone) (PCL),
poly(maleimide), such as poly(alkylenemaleimide), poly(ethylene-alt-maleimide) (PEaMI),
polyaniline (PANI),
chitosan (CS), and
any blend or any copolymer or any cross-linked polymer thereof.

In a further embodiment of the first aspect of the invention, the polymer is selected from the group consisting of:
a polyacrylate, such as polymers of methylmethacrylate (PMMA), (C₁-C₆)alkyl acrylate such as butyl acrylate (PBA) or, ethyl acrylate (PEA), cyanoethylacrylate (PCEA), or blends thereof or co-polymers thereof or cross-linked polymers thereof with trimethylolpropane triacrylate (ETPTA) and/or pentaerythritol tetraacrylate (PETA), and
a polyethyleneglycol optionally comprising one or more cross-linkable groups, such as poly(ethyleneglycol), poly(ethyleneglycol) methacrylate (PEGMA), poly(ethyleneglycol) methyl ether methacrylate, poly(ethyleneglycol) dimethacrylate (PEGDMA), or a mixture thereof and a cross-linked polymer thereof.

In a further embodiment of the first aspect of the invention, the polymer is selected from the group consisting of:
a polyacrylate, such as polymers of butyl acrylate (PBA) or cross-linked polymers thereof with trimethylolpropane triacrylate (ETPTA) and/or pentaerythritol tetraacrylate (PETA), and
a polyethyleneglycol optionally comprising one or more cross-linkable groups, such as poly(ethyleneglycol), poly(ethyleneglycol) methacrylate (PEGMA), poly(ethyleneglycol) methyl ether methacrylate, poly(ethyleneglycol) dimethacrylate (PEGDMA), or a mixture thereof and a cross-linked polymer thereof.

In a further embodiment of the first aspect of the invention, the polymer is selected from the group consisting of:
a polyacrylate, such as polymers of butyl acrylate (PBA) or cross-linked polymers thereof with pentaerythritol tetraacrylate (PETA), and
a polyethyleneglycol optionally comprising one or more cross-linkable groups, such as poly(ethyleneglycol), poly(ethyleneglycol) methacrylate (PEGMA), poly(ethyleneglycol) methyl ether methacrylate, poly(ethyleneglycol) dimethacrylate (PEGDMA), or a mixture thereof and a cross-linked polymer thereof.

In a further preferred embodiment of the first aspect of the invention, the polymer is a cross-linked polymer of butyl acrylate with trimethylolpropane triacrylate (ETPTA) and/or pentaerythritol tetraacrylate (PETA). It is also contemplated in a further embodiment that the polymer is a mixture of butyl acrylate with trimethylolpropane triacrylate (ETPTA) and/or pentaerythritol tetraacrylate (PETA), that is the mixture prior to cross-linking. Preferably, the polymer is a cross-linked polymer of butyl acrylate with pentaerythritol tetraacrylate (PETA). It is also contemplated in a further embodiment that the polymer is a mixture of butyl acrylate pentaerythritol tetraacrylate (PETA), that is the mixture prior to cross-linking.

When the polymer is a mixture of butyl acrylate with trimethylolpropane triacrylate (ETPTA) and/or pentaerythritol tetraacrylate (PETA), the weight ratio of butyl acrylate to trimethylolpropane triacrylate (ETPTA) and/or pentaerythritol tetraacrylate (PETA) is of between 1:1 and 4:1; more preferably of between 2:1 and 4:1; more preferably of between 2:1 and 3:1 even more preferably of about 3:1; and even more preferably of about 113:39. More preferably, the weight ratio of butyl acrylate to trimethylolpropane triacrylate (ETPTA) and/or pentaerythritol tetraacrylate (PETA) is of about 96:43 or about 98:43.

In a further embodiment of the first aspect of the invention, when the polymer is polyethylene glycol optionally comprising one or more cross-linkable groups, said cross-linkable groups are selected from the group consisting of (meth)acrylate, cyanoacrylate, vinyl, thiol, epoxy, amino and hydroxyl, and blends or co-polymers thereof. Such polymers may be cross-linked via thiol-ene chemistry, the free radical polymerization reaction, or the ring-opening reaction of epoxides among other cross linking reactivities known in the art. More preferably, the polymer results from the cross-linking of one or more poly(ethylene glycol) compounds comprising one or more cross-linkable groups, being said groups preferably as defined above, and being more preferably (meth)acrylate.

In a further embodiment of the first aspect of the invention, the polymer is selected from the group consisting of poly(ethyleneglycol) methacrylate (PEGMA), poly(ethyleneglycol) dimethacrylate (PEGDMA), and blends or co-polymers or cross-linked polymers thereof.

In a further embodiment of the first aspect of the invention, the polymer is selected from the group consisting of poly(ethyleneglycol) methyl ether methacrylate, poly(ethyleneglycol) dimethacrylate (PEGDMA), and blends or co-polymers or cross-linked polymers thereof.

In a further embodiment of the first aspect of the invention, the polymer is selected from the group consisting of poly(ethyleneglycol) methyl ether methacrylate or a cross-linked polymer thereof, poly(ethyleneglycol) dimethacrylate (PEGDMA) or a cross-linked polymer thereof, a cross-linked polymer of poly(ethyleneglycol) methyl ether methacrylate with poly(ethyleneglycol) dimethacrylate (PEGDMA) or a polymer thereof, and blends or co-polymers thereof.

In a further embodiment of the first aspect of the invention, the polymer is selected from the group consisting of a mixture of poly(ethyleneglycol) methyl ether methacrylate (with poly(ethyleneglycol) dimethacrylate (PEGDMA) and a cross-linked polymer of poly(ethyleneglycol) methyl ether methacrylate (with poly(ethyleneglycol) dimethacrylate (PEGDMA). Said polymer preferably has a molecular weight of between 100 grams per mole and 10,000 grams per mole. More preferably, said polymer has a molecular weight of between 250 grams per mole and 5,000 grams per mole. Even more preferably, said polymer has a molecular weight of between 500 grams per mole and 1,000 grams per mole. It is contemplated in certain embodiments that the polymer is selected from the group consisting of poly(ethyleneglycol) methyl ether methacrylate, and poly(ethyleneglycol) dimethacrylate (PEGDMA), the polymer having a molecular weight of between 500 grams per mole and 1,000 grams per mole; preferably of 500 or 550 grams per mole.

In a further embodiment of the first aspect of the invention, when the polymer is selected from the group consisting of a mixture of poly(ethyleneglycol) methyl ether methacrylate with poly(ethyleneglycol) dimethacrylate (PEGDMA) and a cross-linked polymer of poly(ethyleneglycol) methyl ether methacrylate with poly(ethyleneglycol) dimethacrylate (PEGDMA), poly(ethyleneglycol) dimethacrylate preferably represents between 20% and 30% in weight of the weight of polymer in the composition.

When the polymer comprises in its molecular formula one or more cross-linkable acrylate groups, the polymer electrolyte composition further optionally comprises an initiator of free radical polymerization, such as azoisobutyronitrile (AIBN). Said initiator compound is preferably present in a weight amount corresponding to 0.1% to 1% of the weight of the polymer electrolyte composition; more preferably in a weight amount of 0.3% of the weight of the polymer electrolyte composition.

In a further embodiment of the first aspect of the invention, the polymer represents about 15% of the weight of the composition.

In a further embodiment of the first aspect of the invention, the polymer is a polymer resulting from the free radical polymerization of a mixture of poly(ethyleneglycol) methyl ether methacrylate with poly(ethyleneglycol) dimethacrylate (PEGDMA). It is also contemplated in a further embodiment that the polymer is a mixture of poly(ethyleneglycol) methyl ether methacrylate with poly(ethyleneglycol) dimethacrylate (PEGDMA), that is the mixture prior to cross-linking.

In a further embodiment of the first aspect of the invention, when the polymer is a mixture of poly(ethyleneglycol) methyl ether methacrylate with poly(ethyleneglycol) dimethacrylate (PEGDMA) or a cross-linked polymer thereof, it is preferred that the weight ratio of poly(ethyleneglycol) methyl ether methacrylate to PEGDA is of between 1:1 and 4:1; more preferably of between 2:1 and 4:1; even more preferably of about 3:1; and even more preferably of about 113:39.

In an another embodiment of the first aspect of the invention, the polymer is selected from the group consisting of poly(ethyleneglycol) methyl ether methacrylate or a polymer thereof, poly(ethyleneglycol) dimethacrylate (PEGDMA) or a polymer thereof and a cross-linked polymer of poly(ethyleneglycol) methyl ether methacrylate with a polymer thereof with poly(ethyleneglycol) dimethacrylate (PEGDMA) or a polymer thereof; and:
the polymer represents from 5% to 90% of the weight of the composition; preferably, the polymer represents from 10% to 60% of the weight of the composition; even more preferably, the polymer represents from 10% to 20% of the weight of the composition; and/or
when the polymer is a mixture of poly(ethyleneglycol) methyl ether methacrylate with poly(ethyleneglycol) dimethacrylate (PEGDMA) or a cross-linked polymer thereof, it is preferred that the weight ratio of poly(ethyleneglycol) methyl ether methacrylate to PEGDMA is of between 1:1 and 4:1; more preferably of between 2:1 and 4:1; even more preferably of about 3:1; and even more preferably of about 113:39.

In an another embodiment of the first aspect of the invention, the polymer is selected from the group consisting of poly(butyl)acrylate and a cross-linked polymer of butyl acrylate with pentaerythritol acrylate; and:
the polymer represents from 5% to 90% of the weight of the composition; preferably, the polymer represents from 10% to 60% of the weight of the composition; even more preferably, the polymer represents from 10% to 20% of the weight of the composition; and/or
when the polymer is a poly(butyl)acrylate and a cross-linked polymer of butyl acrylate with pentaerythritol acrylate, it is preferred that the weight ratio of butyl acrylate to PETA is of between 1:1 and 4:1; more preferably of between 2:1 and 4:1; even more preferably of about 3:1; and even more preferably of about 113:39 or of about 96:43 or of about 98:43.

Thus, in a particular embodiment, the polymer electrolyte of the invention is one wherein:
the second lithium salt is lithium bis(oxalate)borate or lithium difluoro(oxalate)borate LiBF₂(C₂O₄) (LiDFOB);
the weight ratio of the first lithium salt to the second lithium salt is comprised from 1:1 to 4:1; preferably it is comprised from 1:1 to 3:1 and more preferably it is comprised from 1:1 to 2:1;
the lithium salts comprised in the polymer electrolyte composition represent from 10% to 50% in weight of the composition; preferably, the lithium salts comprised in the polymer electrolyte composition represent from 10% to 30% in weight of the composition; even more preferably, the lithium salts comprised in the polymer electrolyte composition represent about 20% of the weight of the composition; and/or
the polymer is selected from the group consisting of (i) poly(ethyleneglycol) methyl ether methacrylate or a cross-linked polymer thereof, poly(ethyleneglycol) dimethacrylate (PEGDMA) or a cross-linked polymer thereof, a cross-linked polymer of poly(ethyleneglycol) methyl ether methacrylate with poly(ethyleneglycol) dimethacrylate (PEGDMA), and blends or co-polymers thereof and (ii) polybutylacrylate (PBA) or a cross-linked polymer thereof with pentaerythritol acrylate (PETA);
the polymer represents from 5% to 90% of the weight of the composition; preferably, the polymer represents from 10% to 60% of the weight of the composition; even more preferably, the polymer represents from 10% to 20% of the weight of the composition; and wherein:
when the polymer is a mixture of poly(ethyleneglycol) methyl ether methacrylate with poly(ethyleneglycol) dimethacrylate (PEGDMA) or a cross-linked polymer thereof, it is preferred that the weight ratio of poly(ethyleneglycol) methyl ether methacrylate to PEGDA is of between 1:1 and 4:1; more preferably of between 2:1 and 4:1; even more preferably of about 3:1; and even more preferably of about 113:39;
when the polymer is a poly(butyl)acrylate or a cross-linked polymer of butyl acrylate with pentaerythritol acrylate, it is preferred that the weight ratio of butyl acrylate to PETA is of between 1:1 and 4:1; more preferably of between 2:1 and 4:1; even more preferably of about 3:1; and even more preferably of about 113:39 or of about 96:43 or of about 98:43;
when the polymer comprises in its molecular formula one or more cross-linkable acrylate groups, the polymer electrolyte composition further optionally comprises an initiator of free radical polymerization, such as azoisobutyronitrile (AIBN).

In a more particular embodiment, the polymer electrolyte of the first aspect of the invention further comprises a plasticizer. Particularly suitable are plasticizer compounds suitable for dissolving the lithium salts of the polymer electrolyte. Such solvents are known in the art and include ether solvents, nitriles, fluorinated sulfonamides, carbonate-based or a combination thereof.

In a more particular embodiment, the polymer electrolyte of the first aspect of the invention further comprises a plasticizer selected from the group consisting of dimethoxy ethane (DME), 1,2-Diethoxyethane (DEE), 1,3-Dioxolane (DOL), Diethyleneglycol dimethyl ether (DEGDME), Triethylene glycol dimethyl ether (G3), tetraethylene glycol dimethyl ether (TEGDME), Poly(ethylene glycol) dimethyl ether (PEGDME), tetrahydropyran (THP), γ-butyrolactone, tetrahydrofuran (THF), 2-methyltetrahydrofuran, diethylether, methyl-tert-butylether, succinonitrile (SN), glutaronitrile (GN), adiponitrile (AN), N,N-dimethylsulfamoyl fluoride (FSA), N,N-dimethyltrifluoromethane-sulfonamide (TFSA), ethyl methyl carbonate (EMC), dimethyl carbonate (DMC), propylene carbonate (PC), ethylene carbonate (EC), fluoroethylene carbonate (FEC), difluoroethylene carbonate (DFEC), and any mixtures thereof.

In a more particular embodiment, the polymer electrolyte of the first aspect of the invention further comprises a plasticizer that is a carbonate-based solvent and is preferably selected from the group consisting of ethyl methyl carbonate (EMC), dimethyl carbonate (DMC), propylene carbonate (PC), ethylene carbonate (EC), fluoroethylene carbonate (FEC), difluoroethylene carbonate (DFEC), and any mixtures thereof.

In a more particular embodiment, the polymer electrolyte of the first aspect of the invention further comprises a plasticizer that is selected from the group consisting of ethyl methyl carbonate (EMC), ethylene carbonate (EC) and a mixture thereof; preferably, it is a mixture of ethyl methyl carbonate (EMC) and ethylene carbonate (EC).

When the plasticizer is a mixture of ethyl methyl carbonate (EMC) and ethylene carbonate (EC), the weight ratio of ethylene carbonate (EC) to ethyl methyl carbonate (EMC) is preferably comprised between 1:1 and 3:2. More preferably, said weight ratio is of about 371:283 or of about 377:288 or of about 405:308.

In a more particular embodiment, the polymer electrolyte of the first aspect of the invention further comprises a plasticizer which represents from 5% to 90% in weight of the polymer electrolyte composition. More preferably, said plasticizer represents from 20% to 80% in weight of the polymer electrolyte composition. Even more preferably, said plasticizer represents from 40% to 80% in weight of the polymer electrolyte composition. Even more preferably, said plasticizer represents from 60% to 80% in weight of the polymer electrolyte composition.

In a more particular embodiment, the polymer electrolyte of the first aspect of the invention further comprises a plasticizer which represents about 65.4% in weight of the composition. In a more particular embodiment, the polymer electrolyte of the first aspect of the invention further comprises a plasticizer which represents about 66.6% in weight of the composition. In a more particular embodiment, the polymer electrolyte of the first aspect of the invention further comprises a plasticizer which represents about 71.3% in weight of the composition.

Thus, in a particular embodiment, the polymer electrolyte of the invention is one wherein:
the second lithium salt is lithium bis(oxalate)borate or lithium difluoro(oxalate)borate LiBF₂(C₂O₄) (LiDFOB);
the weight ratio of the first lithium salt to the second lithium salt is comprised from 1:1 to 4:1; preferably it is comprised from 1:1 to 3:1 and more preferably it is comprised from 1:1 to 2:1;
the lithium salts comprised in the polymer electrolyte composition represent from 10% to 50% in weight of the composition; preferably, the lithium salts comprised in the polymer electrolyte composition represent from 10% to 30% in weight of the composition; even more preferably, the lithium salts comprised in the polymer electrolyte composition represent about 20% of the weight of the composition; and/or
the polymer is selected from the group consisting of: (i) poly(ethyleneglycol) methyl ether methacrylate or a cross-linked polymer thereof, poly(ethyleneglycol) dimethacrylate (PEGDMA) or a cross-linked polymer thereof, a cross-linked polymer of poly(ethyleneglycol) methyl ether methacrylate with poly(ethyleneglycol) dimethacrylate (PEGDMA) or a polymer thereof, and blends or co-polymers thereof; and (ii) polybutylacrylate (PBA) or a cross-linked polymer thereof with pentaerythritol acrylate (PETA);
the polymer represents from 5% to 90% of the weight of the composition; preferably, the polymer represents from 10% to 60% of the weight of the composition; even more preferably, the polymer represents from 10% to 20% of the weight of the composition;
the composition further comprises a plasticizer that is a mixture ethyl methyl carbonate (EMC) and ethylene carbonate (EC) wherein the weight ratio of ethylene carbonate (EC) to ethyl methyl carbonate (EMC) is preferably comprised between 1:1 and 3:2 and the plasticizer preferably represents from 40% to 80% in weight of the polymer electrolyte composition; and wherein:
when the polymer is a mixture of poly(ethyleneglycol) methyl ether methacrylate with poly(ethyleneglycol) dimethacrylate (PEGDMA) or a cross-linked polymer thereof, it is preferred that the weight ratio of poly(ethyleneglycol) methyl ether methacrylate to PEGDA is of between 1:1 and 4:1; more preferably of between 2:1 and 4:1; even more preferably of about 3:1; and even more preferably of about 113:39;
when the polymer is a poly(butyl)acrylate or a cross-linked polymer of butyl acrylate with pentaerythritol acrylate, it is preferred that the weight ratio of butyl acrylate to PETA is of between 1:1 and 4:1; more preferably of between 2:1 and 4:1; even more preferably of about 3:1; and even more preferably of about 113:39 or of about 96:43 or of about 98:43;
when the polymer comprises in its molecular formula one or more cross-linkable acrylate groups, the polymer electrolyte composition further optionally comprises an initiator of free radical polymerization, such as azoisobutyronitrile (AIBN).

Thus, in a particular embodiment, the polymer electrolyte of the invention comprises:
a) a first lithium salt of formula (I) in an amount of between 5% and 15% in weight of the composition, preferably, 11.2% in weight or 11.4% in weight or 9.5% in weight;
b) a second lithium salt that is LiB(C₂O₄)₂ in an amount of between 5% and 10% in weight of the composition, preferably, 8.1% in weight or 8.2% in weight; or, alternatively, a second lithium salt that is LiBF₂(C₂O₄) in an amount of between 5% and 10% in weight of the composition, preferably, 5.1% in weight;
c) the polymer represents between 10% and 20% of the weight of the composition and is a mixture of poly(ethyleneglycol) methyl ether methacrylate and poly(ethyleneglycol) dimethacrylate (PEGDMA) or a cross-linked polymer of poly(ethyleneglycol) methyl ether methacrylate with poly(ethyleneglycol) dimethacrylate (PEGDMA) or a polymer thereof, and blends or co-polymers thereof; preferably, the polymer represents about 15.2% of the weight of the composition, or, alternatively, the polymer represents between 10% and 20% of the weight of the composition and is a poly(butyl)acrylate or a cross-linked polymer of butyl acrylate with pentaerythritol acrylate, preferably, the polymer represents about 13.9% or about 14.1% of the weight of the composition,
d) a plasticizer that represents between 40% and 80% in weight of the composition and is a mixture of ethylene carbonate (EC) and ethyl methyl carbonate (EMC); preferably in a weight ratio of EC to EMC of between 1:1 and 3:2; more preferably, the plasticizer represents 65.5% in weight of the composition; or, alternatively, the plasticizer represents 66.6% in weight of the composition; or, alternatively, the plasticizer represents 71.3% in weight of the composition.

In a more preferred embodiment, the polymer electrolyte of the first aspect comprises:
a) a first lithium salt of formula (I) in an amount of 11.2% in weight of the composition;
b) a second lithium salt that is LiB(C₂O₄)₂ in an amount of about 8.1% in weight of the composition;
c) the polymer represents about 15.2% in weight of the composition and is a mixture of poly(ethyleneglycol) methyl ether methacrylate and poly(ethyleneglycol) dimethacrylate (PEGDMA) or a cross-linked polymer of poly(ethyleneglycol) methyl ether methacrylate with poly(ethyleneglycol) dimethacrylate (PEGDMA) or a polymer thereof, and blends or co-polymers thereof; wherein the weight ratio of poly(ethyleneglycol) methyl ether methacrylate to PEGDA is of about 113:39,
d) a plasticizer that represents about 65.4% in weight of the composition and is a mixture of ethylene carbonate (EC) and ethyl methyl carbonate (EMC); in a weight ratio of EC to EMC of about 371:283; and
e) when the polymer comprises in its molecular formula one or more cross-linkable acrylate groups, the polymer electrolyte composition further optionally comprises an initiator of free radical polymerization, such as azoisobutyronitrile (AIBN).

In a more preferred embodiment, the polymer electrolyte of the first aspect comprises:
a) a first lithium salt of formula (I) in an amount of 11.4% in weight of the composition;
b) a second lithium salt that is LiB(C₂O₄)₂ in an amount of about 8.2% in weight of the composition;
c) the polymer represents between 10% and 20% of the weight of the composition and is a poly(butyl)acrylate or a cross-linked polymer of butyl acrylate with pentaerythritol acrylate, preferably, the polymer represents about 13.9% of the weight of the composition;
d) a plasticizer that represents about 66.6% in weight of the composition and is a mixture of ethylene carbonate (EC) and ethyl methyl carbonate (EMC); in a weight ratio of EC to EMC of about 377:288; and
e) when the polymer comprises in its molecular formula one or more cross-linkable acrylate groups, the polymer electrolyte composition further optionally comprises an initiator of free radical polymerization, such as azoisobutyronitrile (AIBN).

In a more preferred embodiment, the polymer electrolyte of the first aspect comprises:
a) a first lithium salt of formula (I) in an amount of 9.5% in weight of the composition;
b) a second lithium salt that is LiBF₂(C₂O₄) in an amount of about 5.1% in weight of the composition;
c) the polymer represents between 10% and 20% of the weight of the composition and is a poly(butyl)acrylate or a cross-linked polymer of butyl acrylate with pentaerythritol acrylate, preferably, the polymer represents about 14.1% of the weight of the composition;
d) a plasticizer that represents about 71.3% in weight of the composition and is a mixture of ethylene carbonate (EC) and ethyl methyl carbonate (EMC); in a weight ratio of EC to EMC of about 405:308; and
e) when the polymer comprises in its molecular formula one or more cross-linkable acrylate groups, the polymer electrolyte composition further optionally comprises an initiator of free radical polymerization, such as azoisobutyronitrile (AIBN).

As will be apparent to the skilled person, the polymer electrolyte of certain embodiments of the invention may be in the form of a cross-linked composition or in the form of a cross-linkable composition.

The polymer electrolyte of the first aspect of the invention is particularly useful in electrochemical devices such as electrochemical cells or batteries. The second aspect of the invention thus relates to an electrochemical cell or a battery comprising a polymer electrolyte according to the first aspect of the invention.

In a preferred embodiment, the second aspect of the invention relates to an electrochemical cell or a battery comprising a polymer electrolyte according to any preferred or particular embodiment of the first aspect of the invention defined above.

In a preferred embodiment, the second aspect of the invention relates to lithium metal battery comprising a polymer electrolyte according to any preferred or particular embodiment of the first aspect of the invention defined above. A lithium metal battery is a battery characterized in that it comprises an anode consisting essentially of metallic lithium.

In a further preferred embodiment, the second aspect of the invention relates to lithium metal battery comprising a cathode wherein the cathode material is selected from the group consisting of lithium manganese oxide, lithium nickel oxide, lithium nickel manganese cobalt oxide, lithium nickel manganese oxide, lithium manganese cobalt oxide, lithium copper oxide, lithium copper sulphide, lithium iron phosphate, lithium iron sulphide, lithium manganese iron phosphate and lithium nickel cobalt aluminium oxide.

In a further preferred embodiment, the second aspect of the invention relates to lithium metal battery comprising a cathode wherein the cathode material is lithium nickel manganese cobalt oxide such as NMC622.

In a further preferred embodiment, the second aspect of the invention relates to lithium metal battery comprising a membrane, such as a microporous polypropylene membrane, arranged between at least one electrode and the polymer electrolyte in a manner that lithium cations can flow across said membrane between the electrolyte and the surface of said at least one electrode.

In a further preferred embodiment, the second aspect of the invention relates to lithium metal battery having a charge retention capacity of at least 70%; preferably of at least 75%; and more preferably, of at least 80%, after 100 charging cycles, whereby the first cycle was applied at a current of C/20, the 3 following cycles at a current of C/10, and the remaining cycles at C/5, at a temperature of 25° C.; and at a voltage comprised between 3.00 V and 4.25 V.

In a further preferred embodiment, the second aspect of the invention relates to lithium metal battery wherein the cathode material is lithium nickel manganese cobalt oxide and the polymer electrolyte is one wherein:
the second lithium salt is lithium bis(oxalate)borate or lithium difluoro(oxalate)borate LiBF₂(C₂O₄) (LiDFOB);
the weight ratio of the first lithium salt to the second lithium salt is comprised from 1:1 to 4:1; preferably it is comprised from 1:1 to 3:1 and more preferably it is comprised from 1:1 to 2:1;
the lithium salts comprised in the polymer electrolyte composition represent from 10% to 50% in weight of the composition; preferably, the lithium salts comprised in the polymer electrolyte composition represent from 10% to 30% in weight of the composition; even more preferably, the lithium salts comprised in the polymer electrolyte composition represent about 20% of the weight of the composition; and/or
the polymer is selected from the group consisting of: (i) poly(ethyleneglycol) methyl ether methacrylate or a cross-linked polymer thereof, poly(ethyleneglycol) dimethacrylate (PEGDMA) or a cross-linked polymer thereof, a cross-linked polymer of poly(ethyleneglycol) methyl ether methacrylate with poly(ethyleneglycol) dimethacrylate (PEGDMA) or a polymer thereof, and blends or co-polymers thereof; and (ii) polybutylacrylate (PBA) or a cross-linked polymer thereof with pentaerythritol acrylate (PETA);
the polymer represents from 5% to 90% of the weight of the composition; preferably, the polymer represents from 10% to 60% of the weight of the composition; even more preferably, the polymer represents from 10% to 20% of the weight of the composition;
the composition further comprises a plasticizer that is a mixture ethyl methyl carbonate (EMC) and ethylene carbonate (EC) wherein the weight ratio of ethylene carbonate (EC) to ethyl methyl carbonate (EMC) is preferably comprised between 1:1 and 3:2 and the plasticizer preferably represents from 40% to 80% in weight of the polymer electrolyte composition; and wherein:
when the polymer is a mixture of poly(ethyleneglycol) methyl ether methacrylate (with poly(ethyleneglycol) dimethacrylate (PEGDMA) or a cross-linked polymer thereof, it is preferred that the weight ratio of poly(ethyleneglycol) methyl ether methacrylate to PEGDA is of between 1:1 and 4:1; more preferably of between 2:1 and 4:1; even more preferably of about 3:1; and even more preferably of about 113:39;
when the polymer is a poly(butyl)acrylate or a cross-linked polymer of butyl acrylate with pentaerythritol acrylate, it is preferred that the weight ratio of butyl acrylate to PETA is of between 1:1 and 4:1; more preferably of between 2:1 and 4:1; even more preferably of about 3:1; and even more preferably of about 113:39 or of about 96:43 or of about 98:43;
when the polymer comprises in its molecular formula one or more cross-linkable acrylate groups, the polymer electrolyte composition further optionally comprises an initiator of free radical polymerization, such as azoisobutyronitrile (AIBN).

In a further preferred embodiment, the second aspect of the invention relates to lithium metal battery wherein the cathode material is lithium nickel manganese cobalt oxide and the polymer electrolyte comprises:
a) a first lithium salt of formula (I) as defined above in an amount of between 5% and 15% in weight of the composition, preferably, 11.2% in weight;
b) a second lithium salt that is LiB(C₂O₄)₂ in an amount of between 5% and 10% in weight of the composition, preferably, 8.1% in weight;
c) the polymer represents between 10% and 20% of the weight of the composition and is a mixture of poly(ethyleneglycol) methyl ether methacrylate and poly(ethyleneglycol) dimethacrylate (PEGDMA) or a cross-linked polymer of poly(ethyleneglycol) methyl ether methacrylate with poly(ethyleneglycol) dimethacrylate (PEGDMA) or a polymer thereof, and blends or co-polymers thereof; preferably, the polymer represents about 15.2% of the weight of the composition, and
d) a plasticizer that represents between 40% and 80% in weight of the composition and is a mixture of ethylene carbonate (EC) and ethyl methyl carbonate (EMC); preferably in a weight ratio of EC to EMC of between 1:1 and 3:2; more preferably, the plasticizer represents 65.5% in weight of the composition.

In a further preferred embodiment, the second aspect of the invention relates to lithium metal battery wherein the cathode material is lithium nickel manganese cobalt oxide and the polymer electrolyte comprises:
a) a first lithium salt of formula (I) in an amount of 11.4% in weight of the composition;
b) a second lithium salt that is LiB(C₂O₄)₂ in an amount of about 8.2% in weight of the composition;
c) the polymer represents between 10% and 20% of the weight of the composition and is a poly(butyl)acrylate or a cross-linked polymer of butyl acrylate with pentaerythritol acrylate, preferably, the polymer represents about 13.9% of the weight of the composition;
d) a plasticizer that represents about 66.6% in weight of the composition and is a mixture of ethylene carbonate (EC) and ethyl methyl carbonate (EMC); in a weight ratio of EC to EMC of about 377:288.

In a further preferred embodiment, the second aspect of the invention relates to lithium metal battery wherein the cathode material is lithium nickel manganese cobalt oxide and the polymer electrolyte comprises:
a) a first lithium salt of formula (I) in an amount of 9.5% in weight of the composition;
b) a second lithium salt that is LiBF₂(C₂O₄) in an amount of about 5.1% in weight of the composition;
c) the polymer represents between 10% and 20% of the weight of the composition and is a poly(butyl)acrylate or a cross-linked polymer of butyl acrylate with pentaerythritol acrylate, preferably, the polymer represents about 14.1% of the weight of the composition; and
d) a plasticizer that represents about 71.3% in weight of the composition and is a mixture of ethylene carbonate (EC) and ethyl methyl carbonate (EMC); in a weight ratio of EC to EMC of about 405:308.

A method for the preparation of an electrochemical cell or a battery according to the second aspect of the invention is also part of the invention. Said method will become apparent to the skilled person using common general knowledge. In a preferred embodiment, said method comprises the steps of:
(i) providing a cathode for an electrochemical cell or a battery;
(ii) providing an anode for an electrochemical cell or a battery;
(iii) providing a polymer electrolyte as defined in any preferred or particular embodiment of the first aspect of the invention;
(iv) transferring the electrolyte provided in step (iii) on the surface of the cathode provided in step (i) and of the anode provided in step (ii), said surfaces being optionally covered with a microporous membrane; in a manner that the electrolyte is arranged between the cathode and the anode such that lithium cations can flow from the cathode to the anode; and
(v) optionally, when the polymer electrolyte comprises in its molecular formula one or more cross-linkable functional groups, cross-linking the polymer of the polymer electrolyte.

In preferred embodiments, said cross-linking step is a free radical polymerization involving (meth)acrylate groups as cross-linkable functional groups whereby said (meth)acrylate groups are preferably comprised in an acrylate compound or a poly(ethyleneglycol) compound, such as poly(ethyleneglycol) methyl ether methacrylate or PEGDMA.

Preferred materials for the preparation of the electrochemical cell or battery are as defined in the preferred and particular embodiments of the second aspect of the invention.

The optional cross-linking step (v) may be carried out before or after step (iv). It is however preferred that it is carried out after step (iv), as it favours a maximal contact surface between the electrolyte and the electrodes.

As defined above, a third aspect of the invention relates to a method for the preparation of a polymer electrolyte according to the first aspect of the invention comprising the steps of:
(i) providing a lithium salt of formula (I) as defined in the first aspect of the invention;
(ii) providing a second lithium salt as defined in the first aspect of the invention; and in a first alternative,
(iii) dissolving the lithium salts provided in steps (i) and (ii) in a polymer for electrolyte; or, in a second alternative,
(iv) dissolving the lithium salts provided in steps (i) and (ii) in a solvent, and
(v) dissolving a polymer for electrolyte in the mixture obtained in step (iv); and
(vi) optionally, cross-linking the polymer for electrolyte comprised in the mixture resulting from step (iii) or (v).

The method of the first alternative of the third aspect of the invention is particularly suitable when the polymer for electrolyte is in liquid state.

The method of the second alternative of the third aspect of the invention is particularly suitable when the polymer for electrolyte is a solid and/or the lithium salts have low solubility in the polymer for electrolyte.

In preferred embodiments of the third aspect of the invention, the composition of the electrolyte, the second lithium salt, plasticizer, polymer for electrolyte and weight ratios of components of the electrolyte are as defined in any of the particular and preferred embodiments of the first aspect of the invention. In such embodiments, the method of the second alternative of the third aspect of the invention is preferred.

In particular, when the polymer comprises in its molecular formula one or more cross-linkable acrylate groups, the optional cross-linking step (vi) is preferably carried out by free radical polymerization, said reaction being preferably initiated with azoisobutyronitrile (AIBN).

Other cross-linking reactions are known in the art and will become apparent to the skilled person.

Throughout the description and claims the word “comprises” and variations of the word, are not intended to exclude other technical features, additives, components or steps. Furthermore, the word “comprise” encompasses the cases of “consist of” and “consists essentially of”. Additional objects, advantages and features of the invention will become apparent to those skilled in the art upon examination of the description or may be learned by practice of the invention. The following examples are provided by way of illustration, and they are not intended to be limiting of the present invention.

### EXAMPLES

### List of Abbreviations

EC: ethylene carbonate
EMC: ethylmethylcarbonate
LiDFTFSl: (difluoromethanesulfonyl)(trifluoromethanesulfonyl)imide lithium salt
LiBOB: lithium bis(oxalate)borate
Poly(ethylene glycol) methyl ether methacrylate with Mn=500 g/mol
PEGDMA: poly(ethyleneglycol)dimethacrylate with Mn=550 g/mol
AIBN: azoisobutyronitrile
rpm: rounds per minute
RT: room temperature

### Example 1: Preparation of Polymer Gel Electrolytes

Polymer gel electrolytes having the compositions (expressed in weight %) disclosed in Table 1 have been prepared according to the following general procedure. In a first step, a mixture of EC and EMC was prepared by weighing the appropriate amounts of EC and EMC. LiDFTFSl and/or LiBOB was weighted in a vial and the mixture of EC and EMC was added in an appropriate amount. PEGDMA and poly(ethyleneglycol) methyl ether methacrylate were then added to the solution in the appropriate amount and the resulting mixture was left stirring until obtaining an homogeneous solution (approx. 2 h at 300 rpm and RT). AIBN (0.3 wt % of the total weight of the electrolyte) was then added to the solution and the resulting mixture was left stirring 10 min at 300 rpm.

TABLE 1

| | Comparative | Comparative | Example | Example | Example |
|---|---|---|---|---|---|
| Compound | Example 1 | Example 2 | 1a | 1b | 1c |
| EC | 37.2 | 37.2 | 37.2 | 37.7 | 40.5 |
| EMC | 28.3 | 28.3 | 28.3 | 28.8 | 30.8 |
| LiDFTFSI | 0 | 19.3 | 11.2 | 11.4 | 9.5 |
| LiBOB | 19.3 | 0 | 8.1 | 8.2 | 0 |
| LiDFOB | 0 | 0 | 0 | 0 | 5.1 |
| poly(ethyleneglycol) | 11.3 | 11.3 | 11.3 | 0 | 0 |
| methyl ether | | | | | |
| methacrylate | | | | | |
| PEGDMA | 3.9 | 3.9 | 3.9 | 0 | 0 |
| PETA | 0 | 0 | 0 | 4.3 | 4.3 |
| Butyl acrylate | 0 | 0 | 0 | 9.6 | 9.8 |

### Example 2: Preparation of Lithium Metal Batteries Comprising Polymer Gel Electrolytes

Lithium metal batteries comprising the polymer gel electrolytes of Example 1 have been prepared according to the following procedure:
Cathode preparation: LiNi_{0.6}Mn_{0.2}Co_{0.2}O₂(NMC622, purchased from Targray) cathode was composed of 90 wt. % of NMC622, 5 wt. % of conductive carbon (Super C-65), and 5 wt. % of polymeric binder (PVdF). The slurry was made using N-methyl-2-pyrrolidone (NMP) as solvent and after homogenization of the dispersion it was casted on a carbon-coated aluminum current collector. Finally, it was dried overnight at 80° C. under vacuum leading to an average loading of ca. 1.2-1.5 mAh cm⁻² in the cases of cells prepared with the electrolytes of comparative examples 1 and 2 and example 1a; or leading to an average loading of ca. 3 mAh cm⁻² in the cases of cells prepared with the electrolytes of examples 1b and 1c. The electrodes were punched with dimensions 12 mm diameter and subsequently dried again under vacuum at 50° C. before cell assembly.
Anode provision: Li metal disk (China Energy Lithium, 14 mm diameter and 500 μm thickness in the cases of cells prepared with the electrolytes of comparative examples 1 and 2 and example 1a or 50 μm thickness in the cases of cells prepared with the electrolytes of examples 1b and 1c)
Cell assembly: Coin cells were assembled in an Argon filled glovebox using NMC622 (12 mm diameter) electrodes as cathode and prepared as defined above, Celgard 2500 as separator and Li metal disk (China Energy Lithium, 14 mm diameter and 500 μm or 50 m thickness as defined above) as anode. Previously prepared electrolyte solution was casted on the separator and the cell was closed with a crimper. Then, the crosslinking process was applied by keeping the cell at 70° C. for 12 hours.
Following this method, the following batteries have been prepared:
   battery 1, comprising the electrolyte of comparative example 1,
   battery 2, comprising the electrolyte of comparative example 2,
   battery 3, comprising the electrolyte of example 1a,
   battery 4, comprising the electrolyte of example 1b, and
   battery 5, comprising the electrolyte of example 1c.

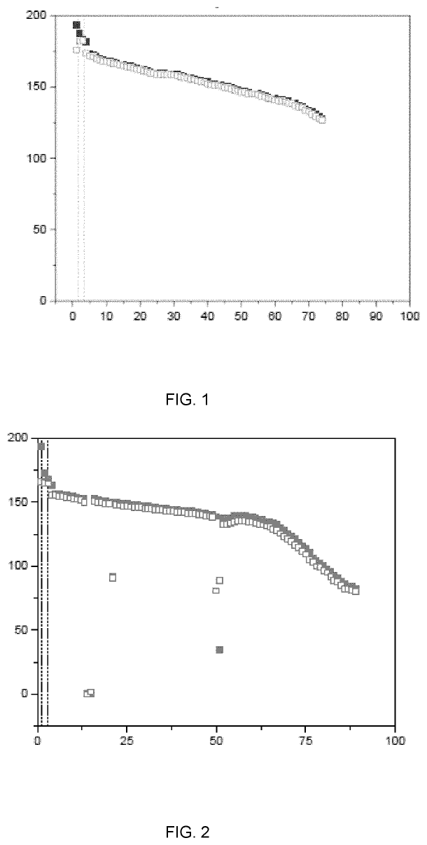

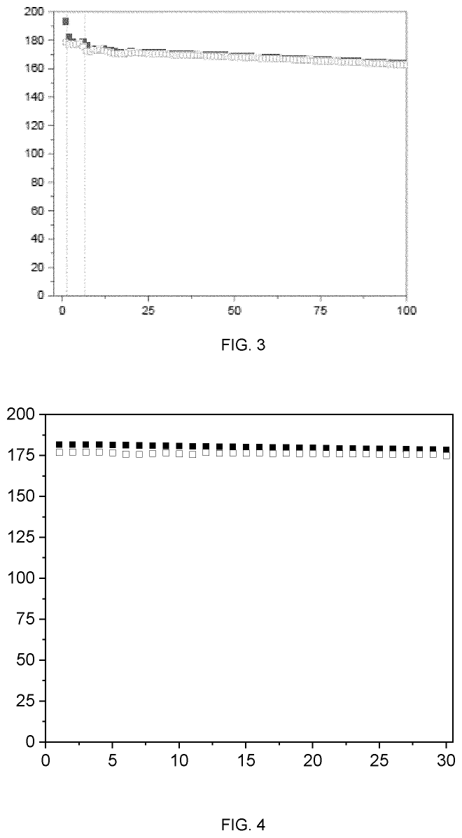

The charge retention capacity of the prepared batteries was tested by cycling galvanostatically between 3.0 V and 4.25 V vs. Li/Li⁺, using a Maccor Battery Tester (Series 4000). The applied protocol for batteries 1, 2 and 3 was based on 1 cycle at a current of C/20, then 3 cycles at C/10, and a constant cycling at C/5 (both charge and discharge) at 25° C. The applied protocol for batteries 4 and 5 was based on 1 cycle at a current of C/20, then 2 cycles at C/10, and a constant cycling at C/10 (both charge and discharge) at 25° C. The first 3 cycles (1 cycle at a current of C/20, then 2 cycles at C/10) are not shown on FIG. 4. The results of these experiments are shown in FIG. 1-4 and show that the electrolyte of the invention advantageously and unexpectedly provides a battery with improved charge retention capacity upon repetitive cycling. In addition, the electrolyte of the invention advantageously allows operating the battery at potentials as high as 4.25 V vs Li/Li⁺ at room temperature while maintaining the charge retention capacity. The batteries comprising the electrolyte of the invention are also less prompt to be subject to corrosion.

1. A polymer electrolyte composition comprising:
a) a polymer for electrolyte;
b) a first lithium salt of formula (I) 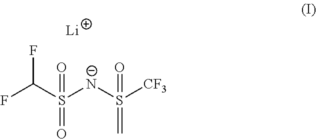
and c) a second lithium salt suitable for lithium metal batteries electrolytes, wherein said second lithium salt is a salt of formula LiB(C₂O₄)₂ or a salt of formula LiBF₂(C₂O₄).

2. (canceled)

3. (canceled)

4. (canceled)

5. (canceled)

6. The polymer electrolyte composition according to claim 1, wherein a weight ratio of the first lithium salt to the second lithium salt is comprised from 1:1 to 2:1.

7. The polymer electrolyte composition according to claim 1, wherein the first and second lithium salts represent from 10% to 30% of the weight of the composition.

8. The polymer electrolyte composition according to claim 1, wherein the polymer comprises in its molecular formula one or more cross-linkable functional groups selected from the group consisting of:
a polyalkylene oxide such as polyethylene oxide (PEO) or polypropylene oxide (PPO),—a polyalkylenimine such as polyethyleneimine (PEI),
a polyalkylene sulphide such as polyethylene sulphide (PES),
a polyalkylene carbonate such as polytrimethylenecarbonate (PTMC), polyethylenecarbonate (PEC) or polypropylenecarbonate (PPC),
a polyacrylate, such as polymers of methylmethacrylate (PMMA), (C1-C6)alkyl acrylate such as butyl acrylate (PBA) or ethyl acrylate (PEA), cyanoethylacrylate (PCEA), or blends thereof or co-polymers thereof or cross-linked polymers thereof with trimethylolpropane triacrylate (ETPTA) and/or pentaerythritol tetraacrylate (PETA),
a polyethyleneglycol,
a polyphosphazene, such as poly[bis(2-(2-methoxyethoxy) ethoxy) phosphazene (MEEP),
a polysiloxane, such as poly(dimethyl siloxane) (PDMS),
polyvinyl alcohol (PVA),
polyvinyl amine (PVAm),
polyvinyl acetate (PVAc),
polyvinyl halide such as polyvinyl chloride (PVC) or polyvinylidene difluoride (PVdF);
polyvinylidene difluoride-hexafluropropylene (PVdF-HFP),
polyacrylonitrile (PAN),
poly(vinylpyrrolidone) (PVP),
poly(2-vinylpyridine) (P2VP),
poly(ε-caprolactone) (PCL),
poly(maleimide), such as poly(alkylenemaleimide), poly(ethylene-alt-maleimide) (PEaMI),
polyaniline (PANI),
chitosan (CS), and
any blend or any copolymer or any cross-linked polymer thereof.

9. The polymer electrolyte composition according to claim 1, wherein the polymer is selected from the group consisting of:
(i)
poly(ethylene glycol) methyl ether methacrylate or a cross-linked polymer thereof,
poly(ethyleneglycol) dimethacrylate (PEGDMA) or a cross-linked polymer thereof,
a cross-linked polymer of poly(ethylene glycol) methyl ether methacrylate poly(ethyleneglycol) methyl ether methacrylate with poly(ethyleneglycol) dimethacrylate (PEGDMA) or a polymer thereof, and
blends or co-polymers thereof, and
(ii)
poly(butyl)acrylate,
a cross-linked polymer of butyl acrylate with pentaerythritol tetraacrylate (PETA) and
blends or co-polymers thereof.

10. The polymer electrolyte composition according to claim 1, wherein the polymer represents from 10% to 20% of the weight of the composition.

11. The polymer electrolyte composition according to claim 1 further comprising a plasticizer.

12. The polymer electrolyte composition according to claim 11, wherein the plasticizer is selected from the group consisting of dimethoxy ethane (DME), 1,2-Diethoxyethane (DEE), 1,3-Dioxolane (DOL), Diethyleneglycol dimethyl ether (DEGDME), Triethylene glycol dimethyl ether (G3), tetraethylene glycol dimethyl ether (TEGDME), Poly(ethylene glycol) dimethyl ether (PEGDME), tetrahydropyran (THP), 7-butyrolactone, tetrahydrofuran (THF), 2-methyltetrahydrofuran, diethylether, methyl-tert-butylether, succinonitrile (SN), glutaronitrile (GN), adiponitrile (AN), N,N-dimethylsulfamoyl fluoride (FSA), N,N-dimethyltrifluoromethane-sulfonamide (TFSA), ethyl methyl carbonate (EMC), dimethyl carbonate (DMC), propylene carbonate (PC), ethylene carbonate (EC), fluoroethylene carbonate (FEC), difluoroethylene carbonate (DFEC), and any mixtures thereof.

13. The polymer electrolyte composition according to claim 11, wherein the plasticizer is a mixture of ethylene carbonate (EC) and ethyl methyl carbonate (EMC); preferably in a weight ratio of EC to EMC of between 1:1 and 3:2.

14. The polymer electrolyte composition according to claim 11, wherein the plasticizer represents between 40% and 80% in weight of the composition.

15. The polymer electrolyte composition according to claim 1, wherein:
a) the first lithium salt of formula (I) is in an amount of between 5% and 15% in weight of the composition;
b) the second lithium salt is LiB(C₂O₄)₂ and is in an amount of between 5% and 10% in weight of the composition;
c) the polymer represents between 10% and 20% of the weight of the composition and is a mixture of poly(ethyleneglycol) methyl ether methacrylate and poly(ethyleneglycol) dimethacrylate (PEGDMA) or a cross-linked polymer of poly(ethyleneglycol) methyl ether methacrylate with poly(ethyleneglycol) dimethacrylate (PEGDMA) or a polymer thereof, and blends or co-polymers thereof; preferably, the polymer represents about 15.2% of the weight of the composition, and
d) polymer electrolyte composition further comprises a plasticizer that represents between 40% and 80% in weight of the composition and is a mixture of ethylene carbonate (EC) and ethyl methyl carbonate (EMC); preferably in a weight ratio of EC to EMC of between 1:1 and 3:2.

16. An electrochemical cell or a battery comprising the polymer electrolyte according to claim 1.

17. A method for preparing the polymer electrolyte according to claim 1 comprising the steps of:
i. providing a lithium salt of formula (I) as defined in claim 1;
ii. providing a second lithium salt as defined in claim 1; and
in a first alternative,
iii. dissolving the lithium salts provided in steps (i) and (ii) in a polymer for electrolyte; or, in a second alternative,
iv. dissolving the lithium salts provided in steps (i) and (ii) in a solvent, and
v. dissolving a polymer for electrolyte in the mixture obtained in step (iv);
and
vi. optionally, cross-linking the polymer for electrolyte comprised in the mixture resulting from step (iii) or (v).

18. The polymer electrolyte composition according to claim 15, wherein:
the first lithium salt of formula (I) is in an amount of 11.2% in weight of the composition;
the second lithium salt is LiB(C₂O₄)₂ and is in an amount of 8.1% in weight of the composition; and
the plasticizer represents 65.5% in weight of the composition.

19. An electrochemical cell or a battery comprising the polymer electrolyte according to claim 11.
